(19) United States
(12) Patent Application Publication
(10) Pub. No.: US 2013/0273502 A1
(43) Pub. Date: Oct. 17, 2013

(54) DENTAL PROBE, A METHOD OF FORMING THE PROBE AND A METHOD OF USING THE PROBE

(71) Applicant: Richard J. Shaw, Hartland, WI (US)

(72) Inventor: Richard J. Shaw, Hartland, WI (US)

(21) Appl. No.: 13/865,276

(22) Filed: Apr. 18, 2013

Related U.S. Application Data
(63) Continuation of application No. 12/077,916, filed on Mar. 24, 2008.

(51) Int. Cl. A61C 15/02

(52) U.S. Cl. CPC A61C 15/02
USPC 433/216; 132/329; 132/322; 264/232

(57) ABSTRACT

A dental probe is disclosed which is designed to be used to probe around and between teeth and surrounding soft tissue in a person's mouth. The dental probe has an arcuately shaped first portion terminating in a blunt tip and a second portion secured to the first portion opposite the tip. The dental probe also has a textured outer surface. The dental probe is capable of transferring a solution or liquid medication onto the teeth and surrounding soft tissue in a person's mouth. A method of molding the dental probe and a method of using the dental probe are also disclosed.

### CROSS REFERENCE TO RELATED APPLICATIONS

This application is a Continuation-In-Part of U.S. Ser. No. 12/077,916, filed Mar. 24, 2008 and entitled: POLAR ANTISEPTIC/ANTIBACTERIAL CONTAINING TOOTHPICK PROBES.

### FIELD OF THE INVENTION

This invention relates to a dental probe, a method of forming the probe and a method of using the probe.

### BACKGROUND OF THE INVENTION

A complete consumer oral hygiene practice includes brushing and flossing. Few people realize flossing is considered more important than brushing by many dental professionals. Yet less than forty percent of the U.S. population flosses. Some of the reasons given why people don't floss include: the complexities of flossing, inconvenience, time required, dexterity, general perceived lack of the importance of flossing, and the discomfort caused by string floss cutting into a person's fingers.

Infected soft tissue, plaque and tartar located between the teeth can incubate bacterial growth and are significant causes of periodontal disease. It is a major contributor to diseases of the soft tissue, tooth decay and many other associated health problems. Infected soft tissue can also contribute to many other health issues.

Flossing does massage the soft tissues in a person's mouth. Flossing also stimulates blood circulation to the surface of the tissue effectively combating bacteria related oral hygiene diseases. Flossing is also supposed to mechanically breakup plaque and tartar. Flossing alone has deficiencies in completing the full function of mechanical breakup of plaque and tartar because it is typically a string and does not effectively contact all of the outer surfaces of the teeth.

However, until now, no viable alternative has been found to effectively replace string flossing to minimize the buildup of bacteria, plaque and tartar in a person's mouth. Periodontal problems remain impervious to full treatment. Many devices and systems have been attempted but all remain incapable to properly introduce an antimicrobial to the sub-gingival regions of a human mouth. Whether water-picks or attempted surface treated devices, none can effectively floss and introduce a controlled solution to the soft tissue between the teeth.

Many of the problems associated with periodontal diseases can be reduce further and possibly be eliminated if a device and method could be invented which has the capability to introduce a solution capable of reducing plaque, tartar and infections of the human mouth while flossing. However, all attempts to date to resolve such problems have failed.

Diseases of the soft tissue remain with serious cost consequences to society. It is not just oral hygiene care but diseases of the soft tissue that can contribute to other health care costs, such as heart disease and other medical problems. It is quite common for medical procedures to be deferred because gingivitis or some other periodontal disease is present in a patient's mouth.

Oral hygiene experts from the U.S. military have stated their preference for flossing over brushing. They feel that it could reduce or possibly eliminate a serious problem with personnel in training and battle conditions if flossing is improved. The U.S. military is experiencing an extraction rate of over ten percent of personnel in battle and training conditions because minor infections in the soft tissue supporting the teeth exacerbates into severe gingivitis or some other periodontal disease because of nerves. A serious concern relates to personnel on covert missions where brushing cannot be done for an assortment of reasons. String flossing is a seriously flawed solution because many times the personnel have dirty hands which can contaminate the string while on a mission.

Now a dental probe, a method of forming the probe and a method of using the probe have been invented which overcomes the above mentioned problems and issues. This dental probe is designed to be used by the general public.

### SUMMARY OF THE INVENTION

Briefly, this invention relates to a dental probe, a method of forming the probe and a method of using the probe. The dental probe has an arcuately shaped first portion terminating in a blunt tip and a second portion secured to the first portion opposite the tip. The dental probe is capable of being used to probe between a person's teeth. In another embodiment, the dental probe has an arcuately shaped, flexible first portion terminating in a blunt tip and a second portion secured to the first portion opposite the tip. This dental probe contains a textured surface which is capable of absorbing and later releasing a solution or medication onto the teeth and surrounding soft tissue of a person's mouth. The solution can be an antimicrobial solution, an antiseptic solution, an antibacterial solution or a combination of an antiseptic and antibacterial solution. The dental probe is constructed such that it can be used to probe between a person's teeth and deliver the solution or medication to the teeth and surrounding soft tissue of a person's mouth.

A method of forming a dental probe having an arcuately shaped first portion terminating in a blunt tip and a second portion secured to the first portion opposite the tip is also disclosed. The dental probe is capable of being used to probe between a person's teeth. This dental probe contains a textured surface which is capable of absorbing and later releasing a solution or medication onto the teeth and surrounding soft tissue of a person's mouth. The method includes the steps of introducing a moldable material into a mold cavity; molding a dental probe having a unique texture and allowing the dental probe to solidify; and removing the dental probe from the mold cavity.

A method of using a dental probe having an arcuately shaped first portion terminating in a blunt tip and a second portion secured to the first portion opposite the tip is further disclosed. The dental probe is capable of being used to probe between a person's teeth and delivering an antimicrobial solution to the teeth and surrounding soft tissue of a person's mouth. This dental probe contains a textured surface which is capable of absorbing and later releasing a solution or medication onto the teeth and surrounding soft tissue of a person's mouth. The method includes the steps of manipulating the blunt tip of the dental probe between a first of two adjacent teeth and the surrounding soft tissue to remove foreign objects and breakup any plaque and tartar that may be present on the teeth. The method also includes manipulating the blunt tip of the dental probe between a second of two adjacent teeth and the surrounding soft tissue to remove foreign objects and breakup any plaque and tartar that may be present on the teeth. The method further includes manipulating the blunt tip of the dental probe around or between additional teeth until all of the teeth in a person's mouth have been probed.

The general object of this invention is to provide a dental probe having a textured surface which is capable of absorbing a solution and later releasing the solution onto the teeth and surrounding soft tissue of a person's mouth. A more specific object of this invention is to provide a dental probe which can mechanically remove foreign objects trapped between a person's teeth, as well as delivering an antimicrobial solution or a medication to the soft tissue and teeth.

Another object of this invention to provide a dental probe having a unique geometry which can caress and massage the soft tissue of a person's mouth.

A further object of this invention is to provide a method of forming the dental probe.

Still another object of this invention is to produce a dental probe using the method of forming the dental probe.

Still further, an object of this invention is to provide method of using the dental probe.

Other objects and advantages of the present invention will become more apparent to those skilled in the art in view of the following description and the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a side view of the dental probe of this invention.

FIG. 2 is an enlarged view of the blunt tip of the dental probe shown in FIG. 1.

FIG. 3 is an end view of the blunt tip shown in FIG. 2.

FIG. 4 is a top view of the dental probe shown in FIG. 1.

FIG. 5 is a cross-sectional view taken along line 5-5 of FIG. 4.

FIG. 6 is a cross-sectional view taken along line 6-6 of FIG. 4.

FIG. 7 is a cross-sectional view taken along line 7-7 of FIG. 4.

FIG. 8 is a cross-sectional view taken along line 8-8 of FIG. 4.

FIG. 9 is a flow diagram depicting a method of forming a dental probe.

FIG. 10 is a flow diagram depicting a method of using a dental probe.

FIG. 11 is a photograph of six test tubes.

FIG. 12 is a photograph of six test tubes.

FIG. 13 is a photograph of six test tubes.

FIG. 14 is a photograph of six test tubes.

FIG. 15 is a photograph of six test tubes.

FIG. 16 is a photograph of six test tubes.

FIG. 17 is a photograph of six test tubes.

FIG. 18 is a photograph of six test tubes.

FIG. 19 is a photograph of six test tubes.

FIG. 20 is a photograph of six test tubes.

FIG. 21 is a photograph of the dental probe being inserted between two adjacent teeth in a person's mouth.

### DETAILED DESCRIPTION OF THE INVENTION

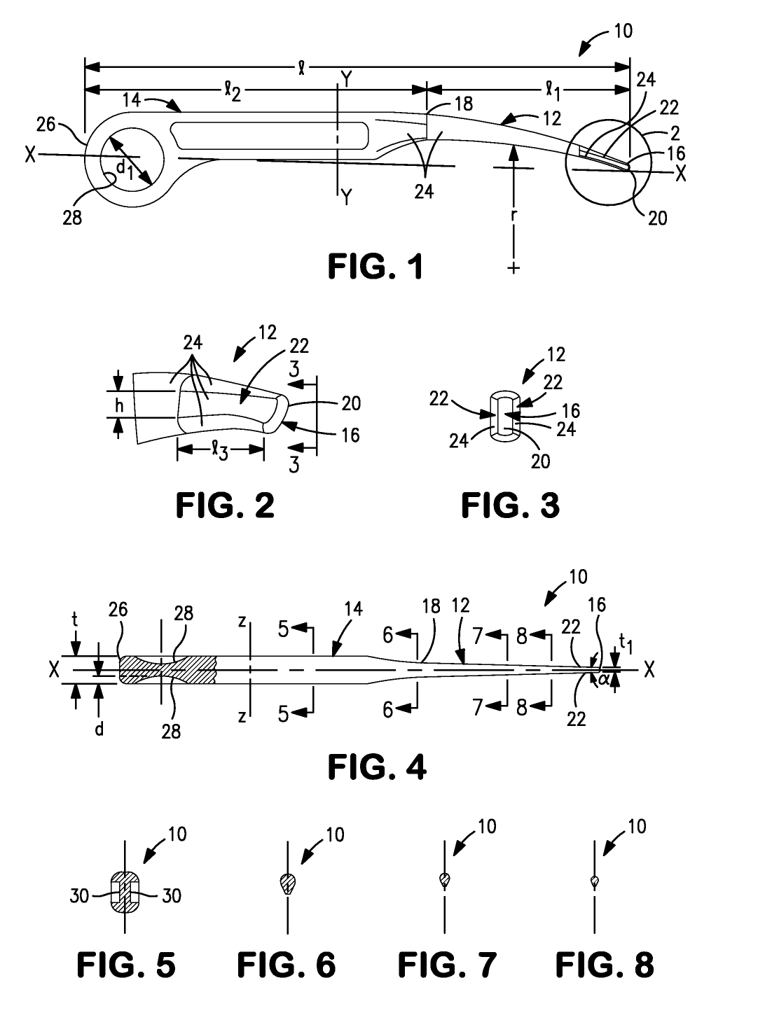

Referring to FIG. 1, a unique dental probe 10 is shown which has a textured surface which is capable of absorbing and later releasing a solution or medication onto the teeth and surrounding soft tissue of a person's mouth. The dental probe 10 may also be called a dental pix. The dental probe 10 is designed to be used by the general public. The dental probe 10 could contain a solution or a medication. The solution can be an antimicrobial, an antiseptic, an antibacterial, a combination antiseptic and antibacterial, or some other form of solution. The dental probe 10 could also contain a medication. Desirably, the medication is in liquid form and is capable of being absorbed into the dental probe 10. Alternatively, the medication can be a paste or a semi-solid which is smeared onto or carried on the outer surface of the dental probe 10 and can be rubbed off by contact with the teeth and/or surrounding soft tissue of a person's mouth. The dental probe 10 can function as a massaging and caressing probe for oral hygiene. The dental probe 10 can be utilized by a human or be used on an animal. A person could use the dental probe 10 to probe around and between his or her teeth. Alternatively, a dentist, dental hygienist or a caregiver could use the dental probe on a patient, on a young child, on an older adult or on an incapacitated person. Likewise, a veterinarian, a pet owner, a farmer or an animal handler could use the dental probe 10 on one or more animals, such as on dogs, cats, farm animals, etc.

The dental probe 10 has a first portion 12 and a second portion 14. The first portion 12 can vary in size, shape and configuration. The first portion 12 is a slender, flexible member used to explore between a person's teeth. The first portion 12 can also be used to massage or caress the soft tissue of a person's mouth located adjacent to or between the teeth. The first portion 12 can be arcuately shaped. By “arcuate” it is meant a shape in the form of a bow or curve. The arcuately shaped first portion 12 can be formed on a radius r which can vary in dimension. Desirably, the radius r is between about 0.3 inches to about 0.7 inches. More desirably, the radius r is between about 0.4 inches to about 0.6 inches. Even more desirably, the radius r is between about 0.4 inches to about 0.5 inches. Most desirably, the radius r is about 0.45 inches. As stated above, the first portion 12 is flexible. By “flexible” it is meant that it is capable of being bent or flexed; pliable. The first portion 12 can also be resilient. By “resilient” it is meant that the material forming the first portion 12 possesses a property that enables it to resume its original shape or position after being bent, stretched, or compressed; elasticity.

The second portion 14 can also vary in size, shape and configuration. The second portion 14 functions as a handle or gripping portion which allows a person to comfortably hold and manipulate the dental probe 10. The second portion 14 is shown as being essentially linear. However, the second portion 14 could be formed in various other shapes, if desired. For example, the second portion 14 could contain a bend or offset to facilitate its use. The second portion 14 does not need to be as flexible as the first portion 12. Therefore, the second portion 14 can be rigid, semi-rigid or be less susceptible to bending or flexing than the first portion 12. Alternatively, the second portion 14 can be constructed to be as flexible as the first portion 12, if desired.

Still referring to FIG. 1, the dental probe 10 has an overall length l. The length l of the dental probe 10 can vary in dimension. Desirably, the length l of the dental probe 10 is less than about 3 inches. More desirably, the length l of the dental probe 10 is less than about 2.5 inches. Even more desirably, the length l of the dental probe 10 is less than about 2.25 inches. Most desirably, the length l of the dental probe 10 is about 2.15 inches.

The first portion 12 of the dental probe 10 has a length l₁ and the second portion 14 of the dental probe 10 has a length l₂. The length l₁ of the first portion 12 can be greater than, equal to or be less than the length l₂ of the second portion 14. Desirably, the length l₁ of the first portion 12 is equal to or less than the length l₂ of the second portion 14. More desirably, the length l₁ of the first portion 12 is less than the length l₂ of the second portion 14. The length l₁ of the first portion 12 can range from about 0.4 inches to about 1 inch. Desirably, the length l₁ of the first portion 12 is at least about 0.6 inches. More desirably, the length l₁ of the first portion 12 is at least about 0.75 inches. Even more desirably, the length l₁ of the first portion 12 is about 0.8 inches. The length l₂ of the second portion 14 can range from about 0.4 inches to about 1.5 inch. Desirably, the length l₂ of the second portion 14 is at least about 0.8 inches. More desirably, the length l₂ of the second portion 14 is about 1 inch. Even more desirably, the length l₂ of the second portion 14 is greater than about 1 inch. Most desirably, the length l₂ of the second portion 14 is about 1.15 inches.

Referring now to FIGS. 1 and 4, the first and second portions, 12 and 14 respectively, form an integral member. By “integral” it is meant a complete unit. The dental probe 10 has a longitudinal central axis X-X, a vertical central axis Y-Y and a transverse central axis Z-Z. The first and second portions, 12 and 14 respectively, extend axially along the longitudinal central axis X-X. Alternatively, at least a portion of the first and second portions, 12 and 14 respectively, can extend axially along the longitudinal central axis X-X. If desired, at least a portion of the second portion 14 can be formed at an angle, or be bent relative to the first portion 12.

It should also be noted that the arcuately shaped first portion 12 curves downward along the vertical central axis Y-Y. This curvature facilitates easy use of the dental probe 10. This curvature also permits the dental probe 10 to be inserted around a tooth or between adjacent teeth in a comfortable manner.

The second portion 14 of the dental probe 10 has a thickness t which can vary in dimension along at least a portion of its length l₂. The first portion 12 varies in thickness and this thickness narrows down to a blunt tip 16. The blunt tip 16 has a thickness t₁. The thickness of the first portion 12 is generally less than the thickness t of the second portion 14. Typically, the thickness t of the second portion 14 is greater than the thickness of the first portion 12 and the first portion 12 reduces in thickness as it approaches the blunt tip 16. The thickness t of the second portion 14 can range from about 0.1 inches to about 0.25 inches. Desirably, the thickness t of the second portion 14 is less than about 0.2 inches. More desirably, the thickness t of the second portion 14 is less than about 0.15 inches. Most desirably, the thickness t of the second portion 14 is about 0.12 inches.

The dental probe 10 can be formed from a variety of materials. The material should be capable of being formed or molded into a desired configuration. Desirably, the dental probe 10 is molded. For example, the dental probe 10 could be injection molded using a two piece mold with a mold cavity, as is well known in the art. Alternatively, the dental probe 10 could be formed using other methods known to those skilled in the art. The dental probe 10 could be formed from a thermoplastic or plastic material. Nylon is a thermoplastic material from which the dental probe 10 can be formed. A particular nylon that is well suited to being molded into the dental probe 10 is Nylon 6. By “nylon” it is meant any of a family of high-strength, resilient synthetic polymers containing recurring amide groups. Type 6, 6 Nylon 101 is the most common commercial grade of nylon, and Nylon 6 is the most common commercial grade of molded nylon. The dental probe 10 could also be formed from some other polymers and/or copolymers having similar characteristics as Nylon 6. By “polymer” it is meant any of numerous natural or synthetic compounds of usually high molecular weight consisting of repeated linked units, each a relatively light and simple molecule. By “copolymer” it is meant a polymer of two or more different monomers.

Nylons are condensation copolymers formed by reacting equal parts of a diamine and a dicarboxylic acid, so that amides are formed at both ends of each monomer in a process analogous to polypeptide biopolymers. Chemical elements included are carbon, hydrogen, nitrogen and oxygen. The numerical suffix specifies the number of carbons donated by the monomers: the diamine first and the diacid second. The most common variant is nylon 6, 6 which refers to the fact that the diamine (hexamethylene diamine, IUPAC name: hexane-1, 6 diamine) and the diacid (adipic acid, IUPAC name: hexanedioic acid) each donate 6 carbons to the polymer chain. As with other regular copolymers like polyesters and polyurethanes, the “repeating unit” consists of one of each monomer, so that they alternate in the chain. Since each monomer in this copolymer has the same reactive group on both ends, the direction of the amide bond reverses between each monomer, unlike natural polyamide proteins which have overall directionality: C terminal->N terminal. In the laboratory, nylon 6, 6 can also be made using adipoyl chloride instead of adipic.

E. I. du Pont de Nemours and Company having an office at 1007 Market Street, Wilmington, Del. 19898 patented nylon 6, 6. In order to compete with E. I. du Pont de Nemours and Company, other companies, particularly the German company, BASF, developed the homopolymer Nylon 6, or polycaprolactam which is not a condensation polymer, but formed by a ring-opening polymerization (alternatively made by polymerizing aminocaproic acid). The peptide bond within the caprolactam is broken with the exposed active groups on each side being incorporated into two new bonds as the monomer becomes part of the polymer backbone. In this case, all amide bonds lie in the same direction, but the properties of Nylon 6 are sometimes indistinguishable from those of nylon 6, 6, except for melt temperature and some fiber properties in products like carpets and textiles. There is also Nylon 9.

The 428° F. (220° C.) melting point of Nylon 6 is lower than the 509° F. (265° C.) melting point of nylon 6, 6.

Still referring to FIGS. 1 and 4, one will clearly see that the first portion 12 terminates in a blunt tip 16. By a “blunt tip” it is meant a dull end, not sharp. The second portion 14 is secured to the first portion 12 at a location opposite to the blunt tip 16. The surface or point of securement between the first and second portions, 12 and 14 respectively, is designated 18. As best seen in FIG. 4, the first portion 12 narrows or tapers downward from the surface or point of securement 18 to the blunt tip 16. The blunt tip 16 has a thickness t₁ which is less than the remainder of the dental probe 10. The thickness t₁ of the blunt tip 16 is less than about 0.015 inches. Desirably, the thickness t₁ of the blunt tip 16 is less than about 0.01 inches. More desirably, the thickness t₁ of the blunt tip 16 is less than about 0.009 inches. Even more desirably, the thickness t₁ of the blunt tip 16 is equal to about 0.008 inches. This narrow dimension facilitates inserting and probing the blunt tip 16 of the dental probe 10 around a single tooth or between two adjacent teeth in a person's mouth. The blunt tip 16 can also be used to caress and massage the surrounding soft tissue of a person's mouth. The surrounding soft tissue is located adjacent to or between the person's teeth. The dental probe 10 can also be constructed to deliver a solution, such as an antimicrobial solution, an antiseptic, an antibacterial, a combination antiseptic and antibacterial, or some other form or a medication to the teeth and the surrounding soft tissue of a person's mouth. More discussion about this added feature will be explained shortly.

Referring now to FIGS. 2-4, the blunt tip 16 has a smooth, rounded end 20. Desirably, the rounded end is semi-circular in shape. The smooth, rounded end 20 does not have any sharp edges. The presence of the smooth, rounded end 20 assures that the soft tissue of a person's mouth will not be cut or impaled by maneuvering and probing the dental probe 10 around and between the various teeth in a person's mouth. In addition, the first portion 12 has a pair of tapered sides 22, 22 which diverge away from the smooth, rounded end 20. In other words, the pair of tapered sides 22, 22 are aligned closest together approximate the blunt tip 16. The pair of tapered sides 22, 22 angle or taper backward toward the remainder of the first portion 12. The pair of tapered sides 22, 22 can be aligned parallel to the vertical central axis Y-Y or be formed at an angle thereto. Desirably, the pair of tapered sides 22, 22 is aligned at an angle to the vertical central axis Y-Y. The pair of tapered sides 22, 22 can taper away from the blunt tip 16 at any desired angle alpha (α), see FIG. 4. The angle of taper α can range from between about 2 degrees to about 45 degrees. Desirably, the angle of taper a can range from between about 5 degrees to about 30 degrees. More desirably, the angle of taper α can range from between about 7 degrees to about 25 degrees. Most desirably, the angle of taper α is less than about 20 degrees.

Referring to FIG. 2, the dental probe 10 has a textured outer surface 24. This textured outer surface 24 can cover the entire dental probe 10 or at least a major portion of the dental probe 10. Desirably, the textured outer surface 24 extends over the entire first portion 12 and over the entire second portion 14. Alternatively, the textured outer surface 24 could extend over the first portion 12 and a portion of the second portion 14. Still another alternative is that the textured outer surface 24 extends over the first portion 12 but not over the second portion 14.

The textured outer surface 24 can contain an “Amtex 9105” texture. “Amtex 9105” is a designation of Amtex, a company having an office at W22410 Edgewood Avenue, Big Bend, Wis. 53103. Amtex is in the business of advanced mold texturing. A textured surface is a far variation from a polished or smooth surface. A textured surface has much more surface area because it is a surface made with added detail including micro-pockets, reservoirs, indentations, etc. This micro-contoured profile brings several attributes. The micro-contoured profile increases the surface tension of the dental probe 10 and facilitates the retention of a greater quantity of a solution or liquid medication. The textured outer surface 24 is also capable of acting as a scouring surface in that it can mechanically contributes to the breakup of plaque and tartar on a tooth as it is moved back and forth. The textured outer surface 24 is further capable of temporarily retaining a solution or a liquid medication. A smooth surface formed on a plastic member will retain very little, if any, of a solution or liquid medication because the cohesion and surface tension of a smooth plastic surface is near zero. The textured outer surface 24 of the dental probe 10 with its micro-contoured profile is able to temporarily retain a solution or a liquid medication and then release this solution or liquid medication onto the teeth and surrounding soft tissues in a person's mouth.

This means that the textured outer surface 24 of the dental probe 10 which has not absorbed a solution or liquid medication can still be used to transport a solution or liquid medication to the teeth and surrounding soft tissue of a person's mouth. First, the dental probe 10 would be dipped or submerged into a solution or liquid medication such that the solution or liquid medication is temporarily retained on the textured outer surface 24. The dental probe 10 is then placed in a person'[s mouth and the first portion 12 is flexed and maneuvered about the outer periphery of a tooth. This action will cause the solution or liquid medication to be transferred to that tooth. If the surrounding soft tissue of a person's mouth is caressed and massaged by the first portion 12 of the dental probe 10, then the solution or liquid medication will be transferred to such surrounding soft tissue.

It should be understood that if the medication is a paste, the paste can be physically retained on the textured outer surface 24 and be transferred to the teeth or surrounding soft tissue by contact therewith.

It should also be understood that no micro-pockets, reservoirs or indentations are actually physically formed into the dental probe 10. Instead, the textured outer surface 24 of the dental probe 10 contains the micro-contoured profile which can temporarily retain a solution or liquid medication.

The maximum moisture saturation of a nylon resin is about 2.7%. By dipping or submerging the dental probe 10, with its textured outer surface 24, into a solution or into a liquid medication, the volume of solution or liquid medication which will cling or assimilated to the textured outer surface 24 of the dental probe 10 can exceed 10%. The textured outer surface 24 allows the solution or liquid medication to be temporarily retained on the dental probe 10. This solution or liquid medication is not absorbed into the interstices of the resin molecules but instead will saturate the textured outer surface. The dental probe 10 can then be inserted into a person's mouth and the teeth and surrounding soft tissue can be caressed or massaged by the first portion 12 of the dental probe 10 whereby the solution or liquid medication is transferred to the teeth and the surrounding soft tissue. After a single use, the dental probe 10 can be discarded.

The textured outer surface 24 allows at least 3 times the amount of solution or liquid medication to be retained on the dental probe 10 versus a smooth surface. Desirably, the textured outer surface 24 allows at least 4 times the amount of solution or liquid medication to be retained on the dental probe 10 versus a smooth surface. In this scenario, the dental probe 10 can be compared to a sponge. The textured outer surface 24 contains micro-pockets which can temporarily retain a solution or liquid medication. Once the dental probe 10 is dipped into a solution or liquid medication, the textured outer surface 24 will retain a high percentage of the solution or liquid medication and this solution or liquid medication can then be immediately transferred to the teeth and the surrounding soft tissue of a person's mouth. Upon contact of the first portion 12 of the dental probe 10 with a tooth, the solution or liquid medication will be released from the micro-pockets of the textured outer surface 24 and will be immediately transferred to the outer periphery of the tooth. Any mechanically interaction between the first portion 12 of the dental probe 10, such as bending, flexing, back and forth movement, etc. can facilitate the transfer of the solution or liquid medication to the outer periphery of the teeth and the surrounding soft tissue in a person's mouth.

This dipping procedure is beneficial in certain instances where the solution or liquid medication is not entirely compatible with a dental probe 10 molded from a nylon resin. For example, fluorine will dissolve nylon and some other resins from which the dental probe 10 could be molded, if the fluorine is in contact with the resin for an extended period of time. Fluoride is a binary compound of fluorine with another element. However, if one dipped a dental probe 10 into a fluorine solution and the fluorine was then immediately transferred from the textured outer surface 24 to the teeth and the surrounding soft tissue of a person mouth, the fluorine would not degrade the dental probe 10. In this scenario, the dental probe 10 would be discarded after a single use.

It should be understood that the medication could be a semi-solid, such as a paste. In this instance, the medication (paste) could be applied to the textured outer surface 24 of the dental probe 10 by various ways known to those skilled in the art and then be transferred to the teeth and the surrounding soft tissue of a person's mouth by physical contact of the dental probe 10 therewith.

Returning to FIG. 2, each of the pair of tapered sides 22, 22 also contains the textured outer surface 24. The textured outer surface 24 can be rough, harsh or coarse, marked by irregularities, protuberances or ridges; not smooth. Alternatively, the textured outer surface 24 can be abrasive or somewhat abrasive. The purpose of the pair of tapered sides 22, 22 is to facilitate breaking up plaque and tartar from the outer periphery of each tooth. By “plaque” it is meant a film of mucus and bacteria on a toothed surface. By “tartar” it is meant a hard yellowish deposit, on the teeth, consisting of organic secretions and food particles deposited by various salts. Since the entire outer surface of the dental probe 10 can be textured, it is the angle of the pair of tapered sides 22, 22 that will contact the outer periphery of a tooth and assist in breaking up the plaque and tartar.

Still referring to FIG. 2, the dimensions of the pair of sides 22, 22 can vary. Each of the pair of sides 22, 22 has a length l₃ measured along the longitudinal central axis X-X and a height h measured parallel to the vertical central axis Y-Y. The length l₃ of each of the pair of sides 22, 22 is less than about 0.3 inches. Desirably, the length l₃ of each of said pair of sides 22, 22 is less than about 0.25 inches. More desirably, the length l₃ of each of the pair of sides 22, 22 is about 0.2 inches. The height h of each of the pair of sides 22, 22 is less than about 0.03 inches. Desirably, the height h of each of the pair of sides 22, 22 is less than about 0.02 inches. More desirably, the height h of each of the pair of sides 22, 22 is about 0.015 inches.

It should be understood that the textured outer surface 24 on each of the pair of tapered sides 22, 22 is identical to that formed on the remainder of the dental probe 10. Because of this, the entire textured outer surface 24 of the dental probe 10 can be used to breakup plaque and tartar on a person's teeth.

Referring again to FIGS. 1 and 4, one will notice that the second portion 14 of the dental probe 10 has a distal end 26. The distal end 26 is spaced apart from the surface or point of securement 18 where the first portion 12 joins the second portion 14. The distal end 26 is an enlarged area compared to the remainder of the dental probe 10 when viewed along the Y-Y axis, see FIG. 1. The distal end 26 has a pair of indentations 28, 28 formed therein. Each of the pair of indentations 28, 28 is depicted as a circle but it should be noted that each indentation 28, 28 can have any geometrical shape imaginable. Desirably, each of the pair of indentations 28, 28 is a circle having a diameter d₁. The diameter d₁ can vary. The diameter d₁ can range from between about 0.2 inches to about 0.75 inches. Desirably, the diameter d₁ is less than about 0.5 inches. More desirably, the diameter d₁ is less than about 0.4 inches. Even more desirably, the diameter d₁ is less than about 0.3 inches.

Each of the pair of indentations 28, 28 also has a depth d, measured parallel to the Z-Z axis. Desirably, each pair of indentations 28, 28 has the same depth d but this could be altered, if desired. The depth d of each pair of indentations 28, 28 can vary. Generally, the depth d of each pair of indentations 28, 28 can range from between about 0.01 inches to about 0.05 inches. Desirably, the depth d of each pair of indentations 28, 28 can range from between about 0.02 inches to about 0.04 inches. More desirably, the depth d of each of the pair of indentations 28, 28 is about 0.03 inches. The size, shape and configuration of the distal end 26 function to permit a person to easily and comfortably grasp the dental probe 10. The size, shape and configuration of the distal end 26 also allow a person to hold the dental probe 10 firmly between his or her thumb and index finger. For example, the inner tip of the thumb and the inner tip of the index finger can easily grip the dental probe 10 therebetween. When held in this manner, the dental probe 10 can easily be maneuvered about the various teeth and gum tissue in a person's mouth.

Referring now to FIGS. 5-8, various cross-sectional views of the dental probe 10 are depicted. In FIG. 5, a cross-sectional view of the second portion 14 is shown taken to the left of the securement surface or point 18. This cross-sectional view reveals an approximately rectangular configuration with rounded corners and a pair of side recesses 30, 30 formed therein. Each of the recesses 30, 30 provides a flat surface where a name, model number, icon, symbol, etc. can be displayed. In FIG. 1, the letters “RxPix” are displayed. It should be understood that any name, model number, icon, symbol, etc. could be displayed in each of the recesses 30, 30. Alternatively, no name or identification need be displayed. In this case, one may wish to eliminate the pair of recesses 30, 30.

FIG. 6 is a cross-sectional view taken at the securement surface or point 18 joining the first portion 12 to the second portion 14. A modified, upside down teardrop profile is shown. The widest part of the modified teardrop shape appears on the top. FIG. 7 is a cross-sectional view of the first portion 12 and is shown taken along sectional line 7-7. As the first portion 12 narrows down as it approaches the blunt tip 16, the cross-section of the first portion 12 likewise gets smaller. A modified, upside down teardrop profile is again shown. The widest part of the modified teardrop shape appears on the top. However, the overall surface area of the first portion 12 shown in FIG. 7 is much smaller than that shown in FIG. 6. FIG. 8 is another cross-sectional view of the first portion 12 taken along sectional line 8-8, which is closer to the blunt tip 16. As the first portion 12 narrows down as it approaches the blunt tip 16, the cross-section of the first portion 12 continues to get smaller. A modified, upside down teardrop profile is again shown. The widest part of the modified teardrop shape appears on the top. However, the overall surface area of the first portion 12 shown in FIG. 8 is much smaller than that shown in FIG. 7.

Referring again to FIG. 1, when the dental probe 10 is formed or molded from a moldable material such as a thermoplastic, a plastic, Nylon 6, etc., the material will contain a plurality of resin molecules having interstices formed therebetween. By “interstices” it is meant a space, especially a small or narrow one, between things or parts. The dental probe 10, upon being formed or being removed from a mold cavity, can be contacted with a solution or a liquid medication. The solution or liquid medication can be absorbed into the plastic and be held between the interstices of the resin molecules. Desirably, the dental probe 10 is immersed in a solution or liquid medication for a predetermined period of time so that a set amount by weight of the solution or liquid medication can be absorbed by the dental probe 10. The solution or liquid medication can vary in composition and concentration. The solution can be an antimicrobial solution, an antiseptic solution, an antibacterial solution, a combination of an antiseptic and an antibacterial, or any other known solution. By “antimicrobial” it is meant an agent that kills microorganisms or inhibits their growth. Antimicrobial medicines can be grouped according to the microorganisms they act primarily against. For example, antibacterials (commonly known as antibiotics) are used against bacteria, and antifungals are used against fungi. They can also be classed according to their function. Antimicrobials that kill microbes are called microbicidal; those that merely inhibit their growth are called microbiostatics. Disinfectants such as bleach are non-selective antimicrobials. By “antiseptic” it is meant of, or relating to, or producing antisepsis or associated with the use of antiseptics. An antiseptic is capable of preventing infection by inhibiting the growth of microorganisms. Sometimes “antiseptic” is used to mean a substance that inhibits the growth of disease causing microorganisms. By “antibacterial” it is meant an agent that inhibits bacterial growth or kills bacteria. The term is often used synonymously with the term antibiotics.

The liquid medication can be any medication known to the medical profession.

The solution can be identical to or similar to LISTERINE®. LISTERINE® is a registered trademark of Johnson & Johnson Corporation having a mailing address of: One Johnson & Johnson Plaza, New Brunswick, N.J. 08933-7001.

Another way in which the dental probe 10 can be produced is to have it actually absorb a solution or a liquid medication immediately upon its removal from a mold. The solution can be any of those taught above. The liquid medication can vary. Any known Federal Drug Administration (FDA) approved medication in liquid form can be absorbed into the dental probe 10 provided it does not degrade the plastic resin from which the dental probe 10 is molded. The liquid medication can be transferred to the soft tissue, such as the gums, of the person as the dental probe 10 is used to caress or massage the soft tissue. By “gum” it is meant the firm connective tissue covered by mucous membrane that envelops the alveolar arches of the jaw and surrounds the bases of the teeth. The amount of liquid medication which can be transferred to the teeth and/or soft tissue of a person's mouth can vary.

The solution, whether an antimicrobial solution, an antiseptic solution, an antibacterial solution, a combination of an antiseptic and an antibacterial, or a liquid medication, can be absorbed into the dental probe 10. By “liquid” it is meant a state of matter characterized by a readiness to flow, little or no tendency to disperse, and relatively high incompressibility. It should be understood that the dental probe 10 is usually formed or molded from clear, opaque or white resin. By “opaque” it is meant impenetrable by light; neither transparent nor translucent. Alternatively, the dental probe 10 could be formed or molded from a colored resin.

It should also be understood that once a solution or liquid medication is absorbed into a clear, opaque or white colored dental probe 10, that the solution or liquid medication may cause the dental probe 10 to change color. The color of the dental probe 10 can be changed to any known color. The dental probe 10 could be changed to a pink, a red, a blue, a yellow, a purple, etc. The color change can be advantageous for it will provide a visual signal to the ultimate user that the dental probe 10 contains a solution or a liquid medication. However, once the dental probe 10 is colored by a solution or liquid medication, it is unlikely that all of the color will leave the dental probe 10 even when a majority of the solution or liquid medication has been released from the dental probe 10.

Another feature of the dental probe 10 is that it could be flavored. The flavor could be absorbed by the dental probe 10 in a similar fashion as the solution or liquid medication is absorbed by the dental probe 10. Alternatively, the flavor can be coated, sprayed, brushed or somehow be attached to the textured outer surface 24 of the dental probe 10 in any manner known to those skilled in the art. A flavor can add a distinctive taste or quality to the dental probe 10. The flavor could be any known flavor. Examples of some flavors include but are not limited to: lemon, lime, citrus, orange, bubblegum, mint, spearmint, etc. The presence of a flavor in or on the dental probe 10 can cause a person using the dental probe 10 to keep the dental probe 10 in his or her mouth for a longer period of time. This is beneficial in that it provides extra time for the solution or liquid medication to be transferred to the teeth and/or soft tissue of the person's mouth.

Another option is to impregnate or coat the dental probe 10 with a specific smell or scent. A savory smell may be appetizing to the nose of a person. Again, this can be beneficial in that it causes a person to use the dental probe 10 more often or to keep the dental probe 10 in his or her mouth for a longer period of time.

During formation of the dental probe 10, the material used to form the dental probe 10 can be contacted with or immersed in a desired solution such that at least about 3, 4, 5, 6, 7, 8, 9, 10 or more percent by weight of the dental probe 10 will be the weight of the solution or liquid medication absorbed into the dental probe 10. Desirably, the dental probe 10 can be contacted or immersed in a desired solution or liquid medication such that at least about 10% by weight of the dental probe 10 will be the weight of the solution or liquid medication that is absorbed into the dental probe 10. More desirably, the dental probe 10 can be contacted or immersed in a desired solution such that at least about 12% by weight of the dental probe 10 will be the weight of the solution or liquid medication that is absorbed into the dental probe 10. Even more desirably, the dental probe 10 can be contacted or immersed in a desired solution such that more than about 15% by weight of the dental probe 10 will be the weight of the solution or liquid medication that is absorbed into the dental probe 10.

It should be understood that about 18% will represent the upper amount of a solution or liquid medication that can be economically absorbed into the dental probe 10.

The dental probe 10 having an absorbed solution or liquid medication is designed to be used by inserting, probing and maneuvering the dental probe 10 around a single tooth or between two adjacent teeth. The dental probe 10 can do this because it is both rigid and durable. A wooden toothpick, by contrast, is quite fragile and could break within a person's mouth if one tried to floss with it. If a wooden toothpick breaks in a person's mouth, it could leave splinters and this is very dangerous.

The blunt tip 16 of the dental probe 10 can be inserted, probed and maneuvered around the various teeth. A reciprocating action can also be obtained wherein the pair of textured surfaces 24, 24 on the pair of tapered sides 22, 22 of the dental probe 10 can breakup any plaque and tartar which has formed on the various teeth. By maneuvering the dental probe 10 in-between and around the circumference of each tooth, one can better remove such plaque and tartar then is currently possible by flossing with string. Furthermore, by using the first portion 12 of the dental probe 10 to massage and caress the soft tissue of a user's mouth, the antimicrobial, the antiseptic, antibacterial, or combination antiseptic/antibacterial solution, or liquid medication can be delivered to the teeth and surrounding soft tissue of the person's mouth. The solution or liquid medication can leach out or be released from the dental probe 10 on contact with the teeth and soft tissue. The movement of the dental probe 10 within a person's mouth, as well as the bending, flexing and mechanical contact of the dental probe 10 with the teeth and/or the surrounding soft tissue will cause the solution or liquid medication to be transferred from the dental probe 10 to the teeth and surrounding soft tissue.

It should be understood that inserting the entire dental probe 10 into a solution or liquid medication immediately upon its removal from a mold for a substantial period of time, such as about 3 weeks, can cause the dental probe 10 to absorb from between about 10% to about 18% of the solution or liquid medication. The exact time that the dental probe 10 needs to be immersed in a solution or liquid medication will depend upon the concentration and type of solution or liquid medication, the resin the dental probe 10 is molded from, the size, shape and configuration of the dental probe 10, the temperature of the solution or liquid medication, etc.

Lastly, the moisture and/or saliva present in a person's mouth may also contribute to the rate of transfer of the solution or liquid medication from the dental probe 10 to the teeth and surrounding soft tissue. No test has been conducted to verify this phenomenon. The actual movement of the dental probe 10 within a person's mouth will permit the solution or liquid medication to be quickly and efficiently transferred to the teeth, gums and surrounding soft tissue.

### Method of Forming the Dental Probe

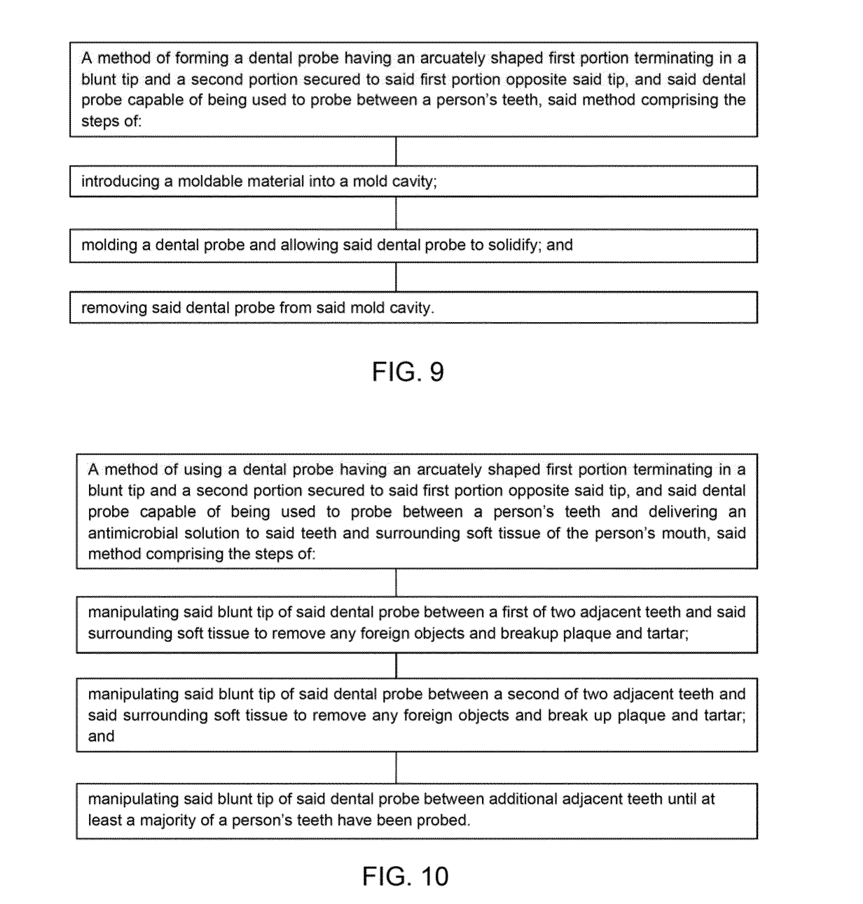

A method of forming a dental probe 10 will now be explained with reference to the flow diagram shown in FIG. 9. The dental probe 10 will have an arcuately shaped first portion 12 terminating in a blunt tip 16, and a second portion 14 secured to the first portion 12 at a securement surface or point 18 located opposite to the blunt tip 16. The dental probe 10 is capable of being used to probe and maneuver about a single tooth or between two adjacent teeth of a person's mouth, as well as caressing and massaging the surrounding soft tissue. The method of forming the dental probe 10 includes introducing a moldable material into a mold cavity. The moldable material can be any of the materials explained above. The moldable material can initially be in the form of solid pellets which can be placed in a hopper. The hopper can deliver the solid pellets to a heated portion of a molding machine where the solid pellets are transformed into a molten state. By “molten” it is meant to be made liquid by heat; to melt. Many thermoplastics, including Nylon 6 and Nylon 6,6, have a melting point ranging somewhere between about 374° F. to about 663° F. (190° C. to about 350° C.).

The molding machine can vary in kind, type and configuration. Desirably, the molding machine is an injection molding machine. Alternatively, the molding machine could be a reaction injection molding machine. Those skilled in the molding art will be aware of various molding machines that could be used to mold the dental probe 10.

In an injection molding machine, the moldable material will be introduced in a molten form into a mold cavity of the molding machine. The mold cavity can be formed from two or more members which cooperate together to enclose a hollow mold cavity. Usually, a mold cavity is constructed of two cooperating members, each forming a half of the finished product. Each of the two mold halves contains a sunken, hollow depression. The bottom or lower surface of each mold half resembles half of the outer surface of the finished product. The mold cavity can vary in size, shape and configuration.

The moldable material can be directed to flow into a closed mold cavity through an inlet opening and will completely fill the mold cavity. The mold in an injection molding machine usually is heated to a temperature above room temperature. Desirably, the mold is heated to a temperature of from between about 90° F. to about 170° F. More desirably, the mold is heated to a temperature of from between about 110° F. to about 150° F. Once the moldable material is present in the mold cavity, it will begin to cool and solidify. The time required for solidification will depend upon the composition of the moldable material, the temperature of the entering molten material, the temperature of the mold, the quantity of moldable material injected into the mold cavity, the size and shape of the mold cavity, whether the mold is cooled or chilled after the molten material is introduced into the mold cavity, etc. Typically a 400° F. molten material will start to cool and solidify once it is introduced into a mold cavity retained at a temperature from between about 110° F. to about 150° F. For a dental probe 10 formed from Nylon 6 and sized as described above, it is estimated that the time required for the molten material to solidify in the mold cavity will range from between about 5 seconds to about 60 seconds. Desirably, the time for the moldable material to solidify in the mold cavity into a dental probe 10 will be less than about 60 seconds. More desirably, the time for the moldable material to solidify in the mold cavity into a dental probe 10 will be less than about 45 seconds. Even more desirably, the time for the moldable material to solidify in the mold cavity into a dental probe 10 will be less than about 30 seconds. Most desirably, the time for the moldable material to solidify in the mold cavity into a dental probe 10 will be about 10 seconds.

It is also advantageous to dry the plastic resin in a controlled environment for a period of time before it enters the mold. The reason for this is to make sure that the resin does not have a high concentration of moisture. Zero moisture is desirable for it will allow the molded dental probe 10 to absorb the greatest amount of solution or liquid medication immediately upon its release from the mold cavity. The plastic resin can be dried at various temperatures but a temperature of from between about 210° F. to about 225° F. works well for Nylon 6. The plastic resin can be dried for various time periods. A time period of from between about 2 to about 4 hours is beneficial for Nylon 6.

It should be understood that the drying time and temperature can vary for different plastic resins. With a dry resin, one can immediately immerse the molded dental probe 10 upon its release from the mold cavity in a solution or liquid medication.

Once the moldable material has solidified into a dental probe 10, the mold cavity is opened and the dental probe 10 is removed. The mold cavity can be constructed such that it will automatically open and close at set intervals. The molded dental probe 10 can be ejected from the mold cavity by a push rod or by some other mechanical mechanism. Alternatively, the molded dental probe 10 can be removed from the mold cavity by hand, by using an external tool, by the use of gravity or by a combination of two or more of these.

Immediately upon removal or ejection of the dental probe 10 from the mold cavity, the dental probe 10 is immersed in a solution or liquid medication for a sufficient period of time. The solution or liquid medication can be any of the solutions or medications described above. Desirably, the solution is an antimicrobial solution. More desirably, the solution contains an antiseptic component, an antibacterial component, or a combination of an antiseptic component and an antibacterial component. The liquid medication can be any that is compatible with the plastic resin. One could use a polar solution, if desired. The solution or liquid medication can be maintained at room temperature, be below room temperature or be above room temperature when the dental probe 10 is immersed therein. Desirably, the solution or liquid medication is maintained at or above room temperature.

Desirably, the dental probe 10 is completely immersed in the solution or liquid medication. Alternatively, one could immerse only a portion of the dental probe 10 in the solution or liquid medication. Another option is to immerse only an end section of the first portion 12 in the solution or liquid medication. The end section of the first portion 12 should include the blunt tip 16 and the pair of textured sides 22, 22. Another way of stating this is with reference to FIG. 4, wherein the section of the first portion 12 from the blunt tip 16 to the point where the cross-section 8-8 is located could be immersed in the solution or liquid medication. Since the dental probe 10 is relatively small, it has been found that a total submersion of the dental probe 10 in the solution or liquid medication is the most efficient and economical.

The time that the dental probe 10 is immersed in the solution or liquid medication can vary. The time can vary from a few seconds, a few hours, a couple of days or even several weeks depending upon the type of solution or liquid medication and the amount one wishes the dental probe 10 to absorb. The time period will depend on how much of the solution or liquid medication one wants the dental probe 10 to absorb by weight. The concentration of the solution or liquid medication can also impact the amount of time the dental probe 10 needs to be immersed. It has been found that over a period of about 3 weeks, the dental probe 10 can absorb from between about 10% to about 18% by weight of the solution or medication when the dental probe 10 is molded from Nylon 6 and the solution is similar to LISTERINE®. This means that the initial weight of the dental probe 10 will increase by from between about 10% to about 18%. It has been found that the dental probe 10 is effective in transferring solution or liquid medication to the teeth and adjoining soft tissues of a person's mouth when the dental probe 10 initially contains at least about 10% by weight of the solution or liquid medication. Desirably, the dental probe 10 will contains at least about 11% by weight of the solution or liquid medication. More desirably, the dental probe 10 will contains more than about 11% by weight of the solution or liquid medication. With the dental probe 10 has at least about 10% by weight of the solution or liquid medication, a purchaser of the dental probe 10 could initially use and then reuse the dental probe 10 for up to two to three days before no more of the solution or liquid medication could be transferred to his or her teeth and surrounding soft tissue. It should be noted that this time period is contingent upon the time the dental probe 10 is initially used in a person's mouth, the temperature at which the dental probe 10 is stored, the humidity at which the dental probe 10 is stored, the located where the dental probe 10 is stored, etc.

If one wished to produce a dental probe 10 which will be used only once and then be discarded, one could submerge or dip the dental probe 10 in a solution or liquid medication and then immediately apply it to the person's teeth and surrounding soft tissue as was explained earlier. In this scenario, the solution or liquid medication is not absorbed into the dental probe 10 but instead is temporarily retained on the textured outer surface 24 before it is transferred. For a dental probe 10 that will be used only once, it is anticipated that the dental probe 10 would adequately work for some solutions and medications when the textured outer surface 24 temporarily retains as little as about 2, 3, 4, 5, 6, 7, 8 or 9 percent by weight of a solution or liquid medication.

For a dental probe 10 that can be used more than once and can efficiently transfer an antimicrobial solution, such as LISTERINE® to a person's teeth and surrounding soft tissue, the dental probe 10 should have absorbed at least about 10% by weight of the solution or liquid medication. Desirably, the dental probe 10 will have absorbed at least 11% by weight of the solution or liquid medication. More desirably, the dental probe 10 should have absorbed at least about 12% by weight of the solution or liquid medication. Even more desirably, the dental probe 10 should have absorbed from between about 10% to about 18% by weight of the solution or liquid medication. Most desirably, the dental probe 10 should have absorbed from between about 10% to about 15% by weight of the solution or liquid medication.

An alternative to immersing the just molded dental probe 10 in a solution or liquid medication is to store the molded dental probe 10 in a moisture free environment after it is formed. By storing the dental probe 10 in a dry, moisture free environment, one can later subject the dental probe 10 to a solution or liquid medication. The solution or liquid medication can be absorbed into the dental probe 10 by immersion for the required time period. Alternatively, the dental probe 10 may be placed in an enclosed container and a gaseous solution can be introduced into the container at a predetermined pressurize value. Those skilled in the art will be aware of various ways in which a solution or liquid medication can be absorbed into the dental probe 10.

After the dental probe 10 has absorbed a sufficient amount or quantity of a solution or liquid medication, the dental probe 10 can be packaged. Desirably, the package is a moisture barrier package which can contain one or more layers of a moisture barrier material. Aluminum foil forms a good moisture barrier. Furthermore, the dental probe 10 can be packaged in a moisture barrier package along with additional solution or liquid medication. The additional solution or liquid medication in the package can be identical, similar to or be different from the solution or liquid medication which was initially absorbed by the dental probe 10. Desirably, the additional solution or liquid medication in the package is of the same composition as the solution or liquid medication that was initially absorbed by the dental probe 10. However, the concentration of the added solution or liquid medication need not be the same as what was initially absorbed by the dental probe 10.

As mentioned above, the solution or liquid medication can vary in composition and concentration. The solution can be an antimicrobial solution, an antiseptic solution, an antibacterial solution, a combination of an antiseptic compound and an antibacterial compound, etc. The medication can also vary in composition and concentration.

Lastly, it should be understood that the dental probe 10 can be immersed in a solution which includes both antiseptic and antibacterial components. The dental probe 10 is immersed for a period of time sufficient for the dental probe 10 to absorb from between about 10% to about 18% by weight of the solution or liquid medication. Desirably, the dental probe 10 can absorb from between about 10% to about 17% by weight of the solution or liquid medication. More desirably, the dental probe 10 can absorb from between about 11% to about 16% by weight of the solution or liquid medication. Even more desirably, the dental probe 10 can absorb from between about 11% to about 15% by weight of the solution or liquid medication.

### Method of Using the Dental Probe

A method of using the dental probe 10 will now be explained with reference to the flow diagram shown in FIG. 10. The dental probe 10 will have an arcuately shaped first portion 12 terminating in a blunt tip 16, and a second portion 14 secured to the first portion 12 at a securement surface or point 18 located opposite to the blunt tip 16. The dental probe 10 is capable of being used to probe around a single tooth or between two adjacent teeth, as well as caress and massage the surrounding soft tissue of a person's mouth. When the dental probe 10 has absorbed a solution or liquid medication, it is also capable of releasing and delivering the solution or liquid medication to the teeth and surrounding soft tissue of the person's mouth. The solution can be an antimicrobial, an antiseptic, an antibacterial, a combination of an antiseptic compound and an antibacterial compound, etc. as was described above. The method of using the dental probe 10 includes the steps of inserting, probing or manipulating the blunt tip 16 of the dental probe 10 around a single tooth or between a first of two adjacent teeth. This action will dislodge any foreign objects, such as small pieces of food, lodged therebetween, and will also breakup any plaque and tartar that may have accumulated on the outer surfaces of the teeth. By “manipulating” it is meant to operate or control the movement of the dental probe 10 by skilled hands. The dental probe 10 can also be used to massage and caress the surrounding soft tissue. When the dental probe 10 has absorbed a solution or liquid medication, such solution or liquid medication can be released and deposited onto the teeth and surrounding soft tissue. The dental probe 10 can be manipulated, moved and maneuvered between the first of two adjacent teeth for any period of time. The time can vary from a few seconds to a minute or more. The dental probe 10 can also be used to caress, massage and gently rub the gums and soft tissues surrounding the teeth for any desired time period.

The orientation of the dental probe 10 can vary during use. Generally, when probing between the upper teeth of a person with the dental probe 10, the arcuate first portion 12 will point downwardly, as is depicted in FIG. 1. When probing between the lower teeth of a person with the dental probe 10, the arcuate first portion 12 will point upward. However, since the spacing between certain teeth on different individuals can vary, one can manipulate, turn or orient the dental probe 10 in a variety of positions so that it best accommodates the situation at hand. In addition, the convex top surface, the concave bottom surface and the side surfaces of the first portion 12 of the dental probe 10 can be used to further caress and massage the gums and soft tissue located above, below or between the teeth. The dental probe 10 is capable of dislodging any food particles stuck between adjacent teeth. In addition, the dental probe 10 can be used to mechanically floss between adjacent teeth much like string floss is presently used today.

The dental probe 10 can be moved in and out, up and down, or be reciprocated back and forth between two adjacent teeth so that the pair of side surfaces 22, 22, located rearward of the blunt tip 16, can rub or scrub the outer perimeters of the teeth and breakup any plaque and tartar that may have accumulated thereon. The rubbing or scrubbing of the teeth with the textured outer surface 24 produces a mechanical action that can break up the plaque and tartar. Furthermore, the solution or liquid medication that was initially absorbed into the dental probe 10 can be released such that it will be released from the dental probe 10. The absorbed solution or liquid medication can be released in any known manner. The solution or liquid medication is then free to chemically act upon the plaque and tartar on the teeth and treat the surrounding soft tissue. The solution can kill microorganisms or inhibits their growth. Depending upon the composition of the solution, the solution may be able to prevent infection by inhibiting the growth of microorganisms or inhibits bacterial growth or even kill the bacteria. The solution is released from the dental probe 10 over time such that it can leach or percolate out or exit the dental probe 10 in a controlled fashion. By “leach” it is meant to remove soluble or other constituents by the action of a percolating liquid. Depending upon the amount of solution or liquid medication that was initially absorbed into the dental probe 10, the solution or liquid medication may be released from the dental probe 10 over a period of days, such that the dental probe 10 can be used several times before it is discarded. If the dental probe 10 has absorbed a liquid medication, the liquid medication can be released to treat the teeth and/or surrounding soft tissue of the person's mouth. The frequency of applying the liquid medication to the soft tissue will depend upon the kind and type of liquid medication being released by the dental probe 10.

Once a person has used the dental probe 10 to probe around or between a first of two adjacent teeth, he or she can then reposition and manipulate the dental probe 10 between a second of two adjacent teeth, as well as caress and massage the surrounding soft tissue. Again, the dental probe 10 can be used to remove any foreign objects lodge therebetween, such as food particles present between the second of two adjacent teeth, and to breakup any plaque and tartar that may have accumulated on the outer surfaces of these teeth. The dental probe 10 can also be used to caress and massage the surrounding soft tissue in the person's mouth. The user can continue to reposition and manipulate the dental probe 10 until all of his or her teeth have been flossed and cleaned. Desirably, all the teeth will be contacted with the dental probe 10 including the outer surfaces of the last two molars or teeth located in both the upper and lower jaw. A person may elect to use the dental probe 10 to floss between some or all of his or her teeth. A person can and should floss around each and every tooth.

It should be understood that the dental probe 10 can also be used to probe around and between dentures, partials and teeth contains crowns or caps.

A major difference between the dental probe 10 of this invention and standard string floss is that the dental probe 10 provides both a mechanical action and a chemical action in breaking up and removing plaque and tartar because it has the ability to release a solution or liquid medication which can chemically act upon such plaque and tartar. Standard string dental floss does not have the ability to release an antimicrobial solution or any other kind of solution which can kill or inhibit the growth of microorganisms. Likewise, a string floss does not contain a medication that can be transferred to the teeth or surrounding soft tissue.

After a person has used the dental probe 10, there is no need to rinse his or her mouth with water and/or with an antimicrobial solution, such as LISTERINE®. Such rinsing would dilute the solution or medication that has been transferred to the teeth and the surrounding soft tissue. By allowing the solution or medication to remain on the teeth and on the surrounding soft tissue, the solution or medication can continue to work to combat infections, and prevent or limit the buildup of plaque and tartar.

Lastly, a person should responsibly discard the used dental probe 10 in an acceptable waste container. The dental probe 10 can be used only once or can be used several times before it has to be discarded. Some people may prefer to use it only once. The dental probe 10 can be placed in a standard waste or trash container present in most bathrooms. The dental probe 10 can also be used outside of the bathroom. If used at various locations other than in a bathroom, the user should properly dispose of the dental probe 10 in a nearby trash receptacle. The dental probe 10 is not meant to be recycled since it may have food particles stuck to it. A used dental probe 10 will also be contaminated with bacteria from a user's mouth. Furthermore, a dental probe 10 that had absorbed a solution or liquid medication may still retain a small amount of such solution or liquid medication and for this reason, should not be recycled.

### Protocol for Testing of Antiseptic Dental Probe Also Identified as RXPIX

The procedure for testing and findings are shown in the following pages.

Protocol for Testing of Antimicrobial RXPIX

1. Overview

For each sample three replicate experiments were preformed. Briefly, a drop of the bacterium E. Coli (strain DH5α) was mixed with a small amount of medium (Loria-Bertani Broth, or LB Broth) and allowed to exchange fluid with the RXPIX for 15 minutes. After this period of time, 2 ml of LB Broth were added to each tube and the bacteria were allowed to grow for 20 hours at 37° C. Observing the turbidity of the broth at this time assessed bacterial viability. Bacterial viability was also assessed analytically by measuring the absorbance of visible light (600 nm).

11. Procedure

A. On day 1, a frozen stock of DH5α was thawed and used to inoculate 5 ml of LB Broth. The LB Broth was incubated at 37° C. for 24 hours and bacterial growth was observed as an increase in turbidity. A small amount (˜50 micro liters) of bacterial medium was removed for use in this experiment.

B. On Day 2, 1 micro liter of E. Coli cells was transferred to each 12×75 mm round bottom tube for antimicrobial testing. In addition, 5 micro liters of fresh LB Broth were added to each tube to allow for fluid exchange. Finally, the RXPIX were removed from their respective fluid-filled containers, dried to remove excess fluid, and inserted into the round-bottom tubes tip first to allow for fluid exchange between the medium, the bacteria, and the tip of the RXPIX. The tubes were then agitated at room temperature for 15 minutes to ensure adequate fluid exchange and to allow the antimicrobial to take effect.

C. After 15 minutes of agitation, 2 ml of LB Broth was added to each round-bottom tube. The tubes were then transferred to a 37° C. incubator and shaken at 275 cycles/minute for a period of 20 hours.

D. After 20 hours of incubation, bacterial viability was assessed.

Visually turbidity of the LB Broth indicated bacterial growth (and therefore negligible antimicrobial activity). Clarity of the LB Broth indicated the absence of bacterial growth and therefore robust antibacterial activity.

E. To further characterize bacterial growth, the absorbance of 600 nm visible light was used to analytically measure turbidity. The broth from each sample was measured with a spectrophotometer equipped with a lamp emitting visible light.

111. Results

Bacterial growth occurred in tubes that were exposed to unsoaked RXPIX. Bacterial growth also occurred in tubes that were exposed to only water (positive control). No bacterial growth occurred in tubes that were incubated with treated RXPIX. Furthermore, no bacterial growth occurred in tubes that were incubated with 70% ethanol (negative control). Detailed results (both digital pictures and spectrophotometric readings) are attached.

IV. Conclusions

The RXPIX are bactericidal and exhibit potent and specific antimicrobial activity.

### BRIEF DESCRIPTION OF COLOR TEST SETS DISCLOSED AND SHOWN

This application contains several color Figures.

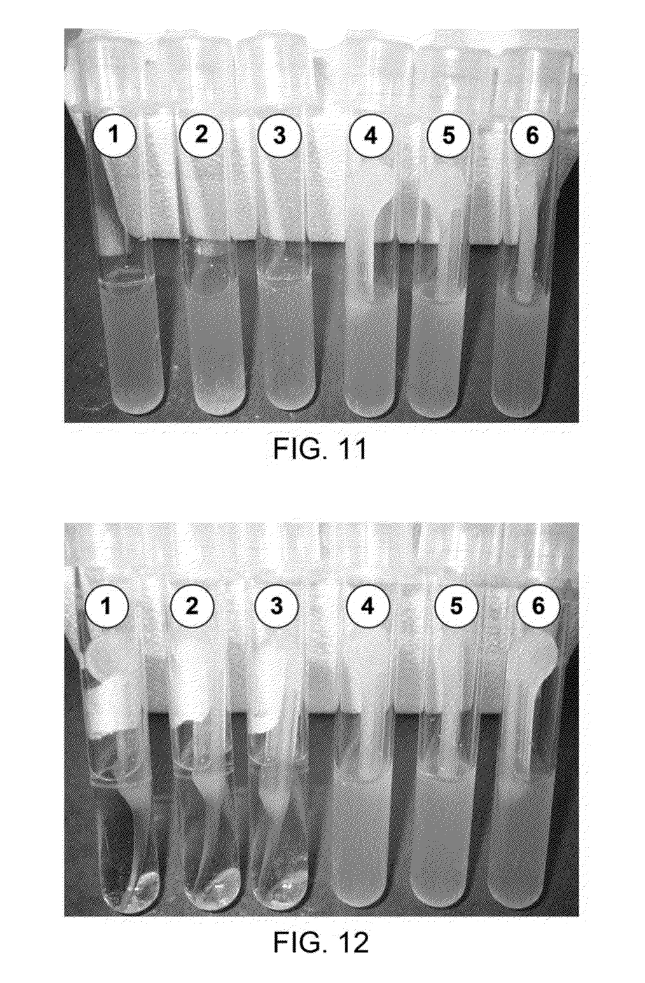

FIG. 11—Triple test showing of inoculated broth vials 1, 2, 3, 4, 5 and 6. This is a negative control showing all vials of broth and each vial inoculated with bacteria and in vials 1, 2, and 3, there is shown a toothpick probe with no antiseptic material contained on the toothpick probe. The turbidity “bacterial growth” shows in inoculated broths in vials 1, 2, 3, 4, 5 and 6, but omitting antiseptic containing toothpick probes of this invention.

FIG. 12—Triple test showing sterility “no turbidity” of inoculated broth vials plus antiseptic toothpick probe 1, 2, and 3, and turbidity of inoculated broth in vials 4, 5, and 6, but without antiseptic containing toothpick probes. Antiseptic of mint mouthwash contained on toothpick probe.

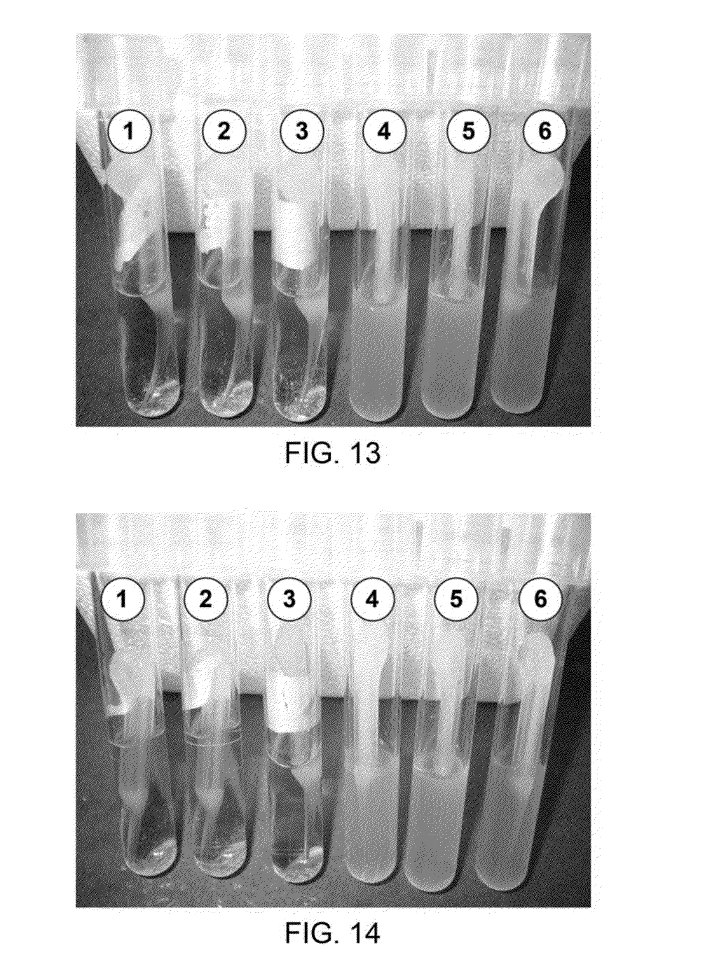

FIG. 13—This is a duplicate test of FIG. 12.

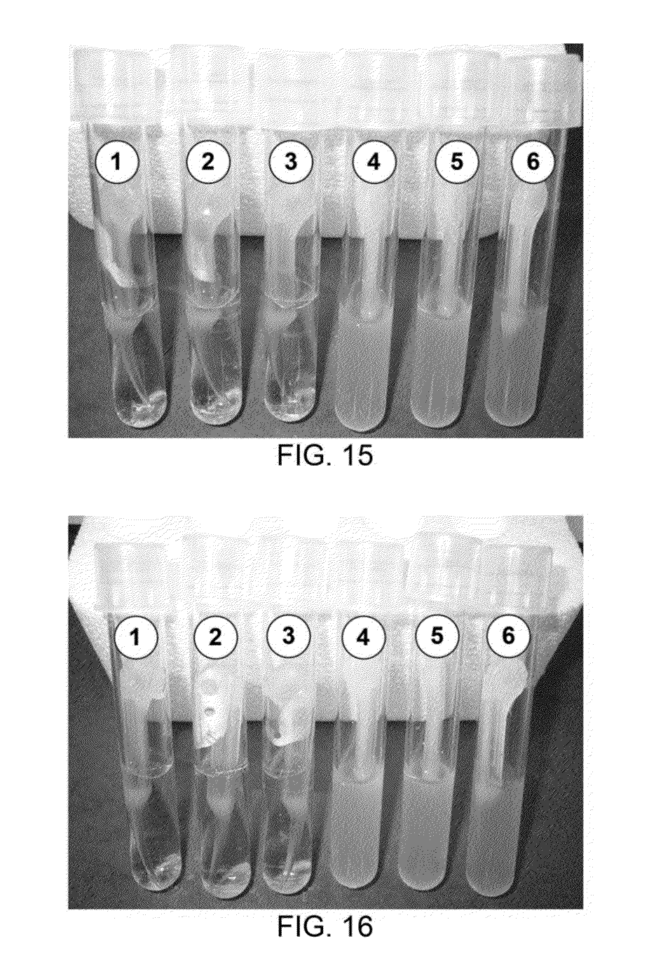

FIG. 14—This is a duplicate test of FIG. 12, but with CITRUS mouthwash.

FIG. 15—This is a duplicate test of FIG. 14, with MINT mouthwash.

FIG. 16—This is a duplicate procedure of FIG. 15 with CITRUS mouthwash plus 0.5% sanguinaria contained on the toothpick probe places in vials 1, 2, and 3.

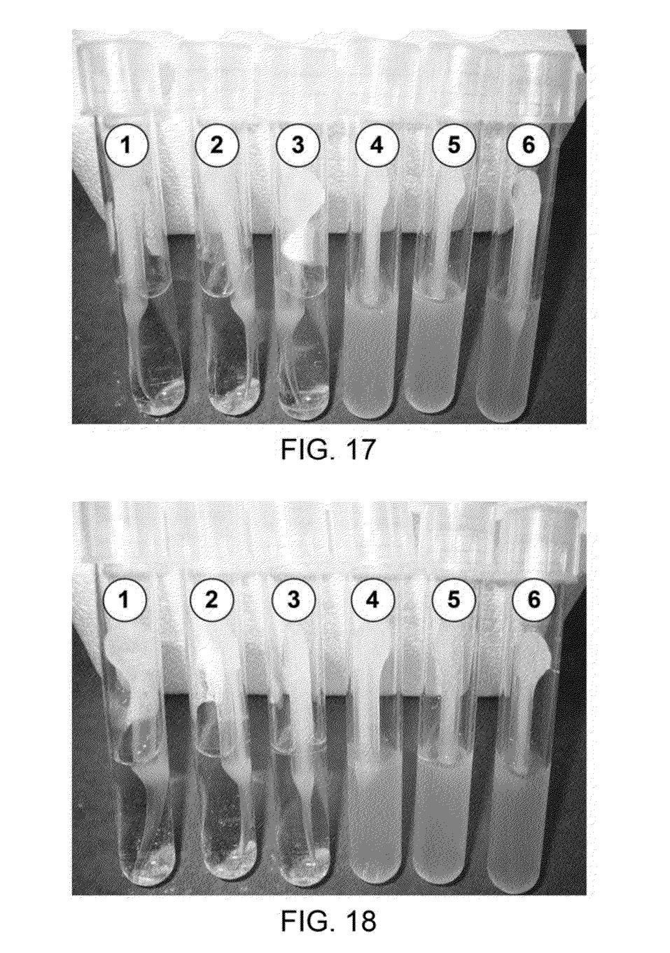

FIG. 17—Toothpick probes immersed in 90% ethyl alcohol, air dried and toothpick probes added to vials 1, 2, and 3.

FIG. 18—This is a duplicate procedure of FIG. 17.

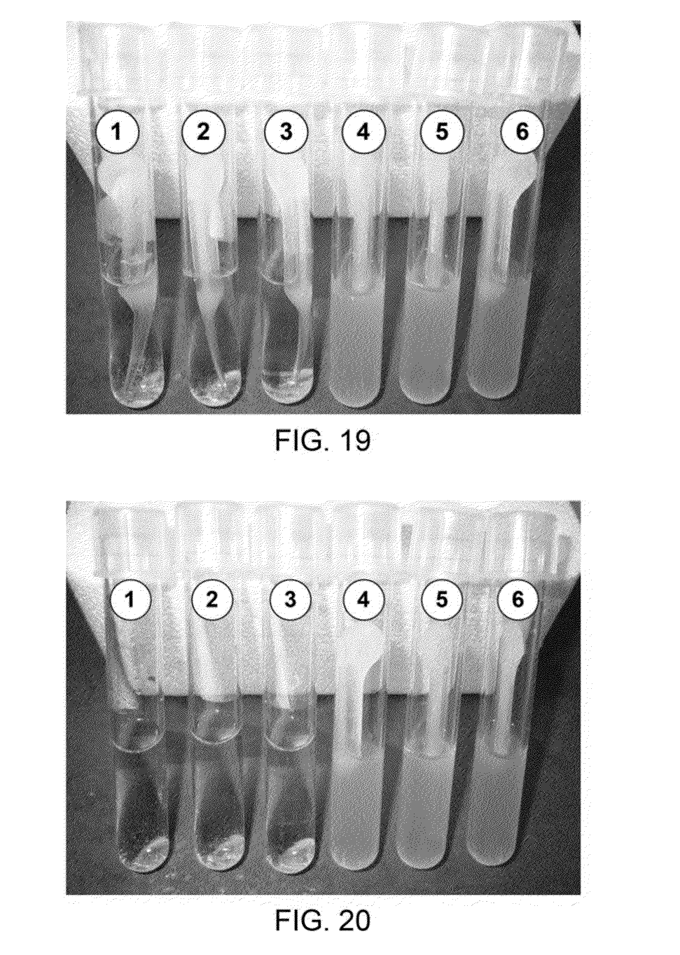

FIG. 19—Toothpick probes immersed in 90% ethyl alcohol, air dried, plus 0.5% sanguinaria, added to vials 1, 2, and 3.

FIG. 20—200 micro liters of 70% ethyl alcohol added to each inoculated vial 1, 2, and 3, as a negative control (not showing bacterial growth), but bacterial growth shown by turbidity of vials 4, 5, and 6.

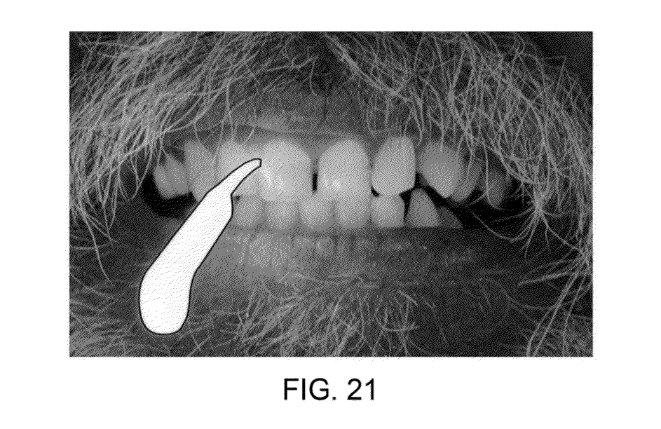

FIG. 21—Toothpick probe containing antiseptic/antibacterial shown in use in vivo (human mouth).

### Description of Antiseptic Solutions Used in Above Described Protocol

Mint mouthwash—Equate antiseptic blue mint mouth rinse containing as active ingredients: Eucalyptol 0.092%; Menthol 0.042%; Methyl salicylate 0.060%; and Thymol 0.064%. Inactive ingredients are: Water, alcohol 21.6%; sorbitol solution, flavor, poloxamer 407; benzoic acid; sodium saccharin, sodium benzoate; and FD&C green no. 3. The Citrus orange color mouth wash—Equate antiseptic citrus mouth rinse has the same active ingredients as the above described Mint mouthwash. The inactive ingredients of this Citrus mouthwash are: Water, alcohol 21.6%; sorbitol solution, flavor, poloxamer 407; benzoic acid; sucralose and/or sodium saccharin, sodium benzoate; and cochineal extract.

The dental probe 10 of this invention is called RXPIX for identification purposes in the protocol and is synonymous with toothpick probe molded or formed of Nylon 6, readily absorbs moisture up to 8% of its weight and it is this moisture uptake by Nylon 6 that is the gist of this invention.

To mold Nylon 6 into a dental probe requires heating of Nylon 6 to a plastic state then injecting into a mold cavity, and the dental probe moldings of the Nylon 6 are immediately captured, on ejection from the molding cavities, and protected from absorption of moisture and water. After capture of the Nylon 6 dental probe moldings from the molding cavities and protected from moisture absorption, the dental probes constructed from Nylon 6 are immersed in a liquid antiseptic/antibacterial solution at which time the antiseptic/antibacterial permeates the dental probes, after which the dental probes, immersed in the antiseptic are dried and ready for subsequent use as an antiseptic/antibacterial dental probe in the human mouth invivo, between the teeth or on the gums.

In all of the above protocol results described above, the turbidity shows bacterial growth, and clarity shows no bacterial growth which shows efficacy of the procedure and protocol described, including molded Nylon 6 absorption of an antiseptic/antibacterial solution, and subsequently leachable from the Nylon 6 in a liquid media, or as used invivo, in the human mouth as a dental probe.

While the invention has been described in conjunction with a specific embodiment, it is to be understood that many alternatives, modifications and variations will be apparent to those skilled in the art in light of the foregoing description. Accordingly, this invention is intended to embrace all such alternatives, modifications and variations which fall within the spirit and scope of the appended claims.

I claim:

1. A dental probe having an arcuately shaped first portion terminating in a blunt tip and a second portion secured to said first portion opposite said tip, said dental probe capable of being used to probe around and between a person's teeth.

2. The dental probe of claim 1 wherein said dental probe has a textured outer surface is capable of temporarily retaining a solution or medication and immediately transferring the solution or medication onto said teeth and surrounding soft tissue in a person's mouth.

3. The dental probe of claim 2 wherein said textured outer surface has a micro contoured profile which increases surface area and permits said dental probe to temporarily retain a solution or medication.

4. The dental probe of claim 3 wherein said dental probe provides both a mechanical and a chemical ability to breakup plaque and tartar from a person's teeth, said textured surface of said dental probe capable of being dipped in a solution or liquid medication and then immediately transferring said solution or liquid medication onto teeth and surrounding soft tissue in a person's mouth to breakup plaque and tartar.

5. The dental probe of claim 1 wherein said second portion is linear and contains an enlarged end.

6. The dental probe of claim 1 wherein said dental probe provides both a mechanical and a chemical ability to breakup plaque and tartar from a person's teeth, said dental probe capable of absorbing at least about 10% by weight of a solution or liquid medication over a period of time and then releasing said solution or liquid medication onto teeth and surrounding soft tissue in a person's mouth to breakup plaque and tartar.

7. The dental probe of claim 1 wherein said blunt tip has a semi-circular shape and a pair of sides that diverge away from said blunt tip.

8. The dental probe of claim 1 wherein said blunt tip has a modified, upside down teardrop cross-sectional configuration.

9. The dental probe of claim 1 wherein said first and second portions each have a length, and the length of said first portion is less than the length of said second portion.

10. The dental probe of claim 1 wherein said dental probe is molded from a plastic resin containing a plurality of molecules and a solution or liquid medication is absorbed and held between interstices of said molecules, and said solution or liquid medication is capable of being released to the teeth and surrounding soft tissue of a person's mouth.

11. A dental probe having an arcuately shaped, flexible first portion terminating in a blunt tip and a second portion secured to said first portion opposite said tip, said dental probe having a textured outer surface which is capable of temporarily retaining a solution or liquid medication and immediately releasing said solution or liquid medication onto teeth and surrounding soft tissue in a person's mouth.

12. The dental probe of claim 11 wherein said solution is an antimicrobial solution.

13. The dental probe of claim 11 wherein said dental probe is molded from Nylon 6.

14. A method of forming a dental probe having an arcuately shaped first portion terminating in a blunt tip and a second portion secured to said first portion opposite said tip, and said dental probe capable of being used to probe around and between a person's teeth, said method comprising the steps of:
a) introducing a moldable plastic resin into a mold cavity;
b) molding a dental probe which is capable of probing around and between adjacent teeth and surrounding soft tissue of a person's mouth;
c) allowing said dental probe to solidify;
d) removing said dental probe from said mold cavity; and
e) immediately immersing said dental probe in a solution or a liquid medication for a sufficient time to absorb at least about 10% by weight of said solution or liquid medication.

15. The method of claim 14 further comprising drying said plastic resin before it is introduced into a mold cavity.

16. The method of claim 14 further comprising packaging said dental probe which has absorbed said solution or liquid medication in a moisture barrier package.

17. The method of claim 16 further comprising packaging said dental probe which has absorbed said solution or liquid medication in a moisture barrier package containing additional solution or liquid medication.

18. The method of claim 14 further comprising molding a textured outer surface onto said dental probe during said molding step, said textured outer surface capable of temporarily retaining a solution or liquid medication which can be immediately transferred onto the teeth and surrounding soft tissue in a person's mouth.

19. A method of using a dental probe having an arcuately shaped first portion terminating in a blunt tip and a second portion secured to said first portion opposite said tip, said dental probe capable of being used to probe around and between a person's teeth, said method comprising the steps of:
a) manipulating said blunt tip around and between a first of two adjacent teeth to remove any foreign objects lodged therebetween and to breakup plaque and tartar present on said teeth;
b) repositioning said dental probe and manipulating said blunt tip around and between a second of two adjacent teeth to remove any foreign objects lodged therebetween and to breakup plaque and tartar present on said teeth; and
c) repositioning said dental probe and manipulating said blunt tip around and between additional teeth to breakup plaque and tartar present on said teeth.

20. The method of claim 18 further comprising discarding said dental probe in an acceptable waste container.
